(19) United States
(12) Patent Application Publication
(10) Pub. No.: US 2022/0357045 A1
(43) Pub. Date: Nov. 10, 2022

(54) TEMPERATURE LIMITING SOFTWARE TO ENABLE USE OF TEMPERATURE-SENSITIVE COMPONENTS ON INDUCTION COOKTOPS

(71) Applicant: Electrolux Home Products, Inc., Charlotte, NC (US)

(72) Inventors: Steven Swayne, Nashville, TN (US); Jonathan Didas, Aurora, CO (US); Lee Chappell, Hendersonville, TN (US); Paul Zhang, Hendersonville, TN (US)

(21) Appl. No.: 17/308,450

(22) Filed: May 5, 2021

(51) Int. Cl. F24C 7/08

(52) U.S. Cl. CPC F24C 7/088; F24C 7/083

(57) ABSTRACT

A cooking appliance includes a cooktop having a cooking zone with at least one heating element beneath the cooktop in the cooking zone, a temperature sensor that detects the temperature of the cooking zone, and a controller. The controller executes a temperature-protect mode upon receiving an indication of a presence of a temperature-sensitive component on the surface of the cooktop by adjusting power supplied to the heating element in response to a detected temperature of the cooking zone approaching, meeting or exceeding a threshold temperature in order to ensure that the detected temperature does not exceed the threshold temperature beyond a predetermined degree and/or for a predetermined period of time. The threshold temperature is predetermined to be one that will not damage the temperature-sensitive component.

### FIELD OF INVENTION

The following description relates generally to a cooking appliance and, more specifically, to an induction cooktop or hob with a temperature-feedback control that protects certain temperature-sensitive or heat-sensitive components used on the cooktop.

### BACKGROUND OF INVENTION

Conventional induction cooking appliances regulate the power supplied to the induction coil, independent of temperature feedback. Certain high temperatures, however, may damage temperature-sensitive components, such as protective mats or cooking utensils with a non-stick coating such as PTFE-coated pots and pans, which may be used on the cooktop surface.

### SUMMARY

According to one general aspect, a cooking appliance may be provided. The cooking appliance has a cooktop having a cooking zone and at least one heating element disposed beneath the cooktop in the cooking zone, a temperature sensor configured to detect the temperature of the cooking zone, and a controller. The controller is configured to execute a temperature-protect mode upon receiving an indication of a presence of a temperature-sensitive component on a surface of the cooktop. In the temperature-protect mode, the controller is configured to receive from the temperature sensor a temperature signal corresponding to the detected temperature of the cooking zone; and adjust power supplied to the heating element in response to the detected temperature approaching, meeting or exceeding a threshold temperature in order to ensure that the detected temperature does not exceed the threshold temperature beyond a predetermined degree and/or for a predetermined period of time. The threshold temperature is predetermined to be one that will not damage the temperature-sensitive component.

In another general aspect, a method for operating a temperature-protect mode on a cooking appliance may be provided. The method includes receiving an indication of a presence of a temperature-sensitive component on a cooktop surface in a cooking zone thereof; receiving from a temperature sensor a temperature signal corresponding to a detected temperature of the cooking zone; and adjusting power supplied to a heating element that supplies cooking energy to said cooking zone in response to said detected temperature approaching, reaching or exceeding a threshold temperature in order to ensure that the detected temperature does not exceed the threshold temperature beyond a predetermined degree and/or a predetermined period of time period of time, said threshold temperature having been predetermined to be one that will not damage said temperature-sensitive component.

Other features and aspects may be apparent from the following detailed description, the drawings, and the claims.

### BRIEF DESCRIPTION OF THE DRAWINGS

FIG. 1 is a simplified perspective view of an example cooking appliance;

FIG. 2 is a schematic, plan view of an example cooktop and a protective mat placed above one of the heating elements;

FIG. 3 is a schematic view of an example user interface; and

FIG. 4 is a flowchart illustrating a temperature limiting cooking method.

### DETAILED DESCRIPTION

Examples will now be described more fully hereinafter with reference to the accompanying drawings in which example embodiments are shown. However, aspects may be embodied in many different forms and should not be construed as limited to the embodiments set forth herein. Moreover, certain terminology is used herein for convenience only and is not to be taken as a limitation.

Induction cooktops have become popular recently because of their rapid heating and efficient performance, and their smooth, ceramic glass cooking surfaces having a pleasing appearance, which are easy to clean. However, certain induction cooking utensils, such as pots or pans made from cast-iron, carbon steel, and some stainless steel pans, for example, may gouge, scratch, or even crack the glass cooktop. In order to prevent damage to the cooktop surface from such cooking utensils, a protective mat or pad may be placed on the cooktop above one or more cooking zones to protect the glass surface. However, such protective mats generally are temperature resistant only up to a certain predetermined temperature, such as 500° F., for example. This temperature can be easily exceeded in an induction cooking zone under normal operation, thus charring or otherwise destroying the mat. It may be desirable to ensure that, when a protective mat is placed on the cooktop, the cooktop surface does not reach or exceed a predetermined temperature, e.g. 500° F., known to be safe for the protective mats.

Separately, certain induction cooking utensils contain polytetrafluoroethylene (PTFE) coatings, such as Teflon®-brand coatings, for example, or other non-stick coatings applied at the inner (cooking) surface of the cooking utensil. Such coatings provide a non-stick surface on which to cook food, making cleanup easier. However, at or above certain temperatures, e.g. 500° F., these coatings can be damaged and caused to delaminate from the utensil, or even to char or offgas, and release undesirable substances in the utensil and/or the air. In order to utilize non-stick coated utensils for induction cooking, it may be desirable to ensure that, when a non-stick coated utensil is placed on the cooktop, the utilized cooking zone does not reach or exceed a predetermined temperature, e.g. 500° F., known to be safe for the non-stick coatings.

The cooking appliance and method described herein regulate the power supplied to an induction coil (or multiple induction coils that may be part of a common cooking zone), based on a temperature-feedback control using a temperature sensor disposed beneath the glass cooktop. In this manner, temperature of the cooking zone can be confined not to exceed a predetermined known-safe temperature for temperature-sensitive components, such as protective mats and/or non-stick-coated pans that may be in use on the cooktop.

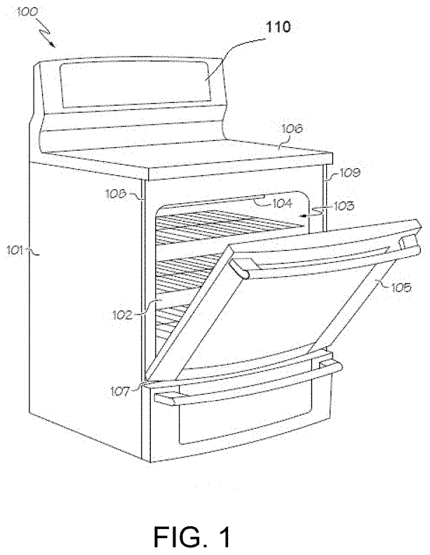

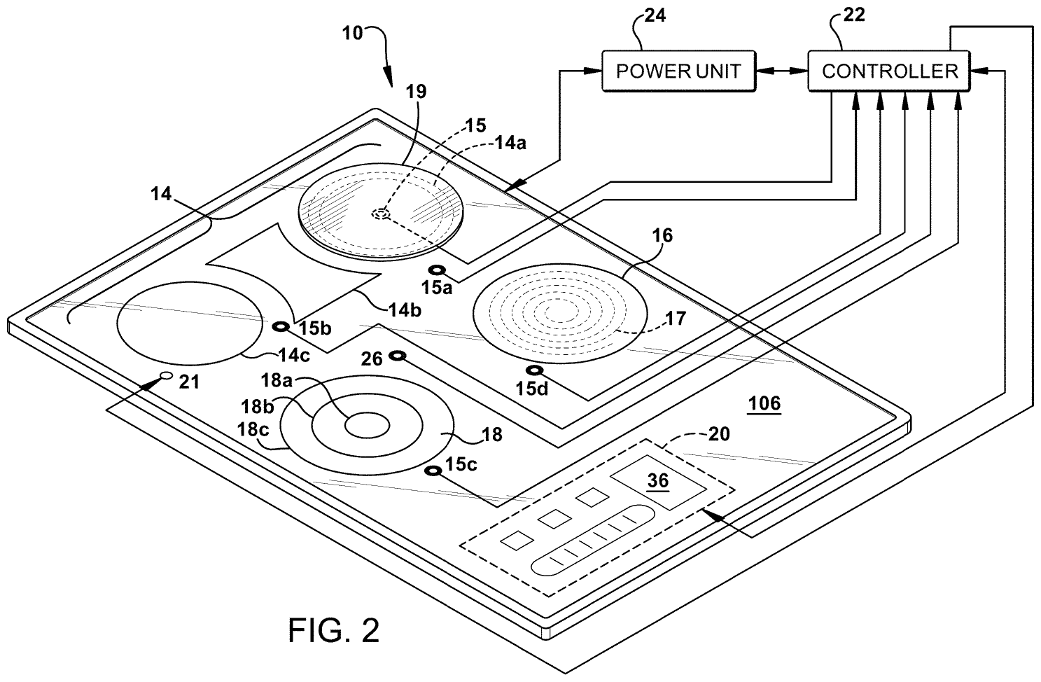

FIG. 1 shows an illustrative embodiment of a cooking appliance, such as an oven range 100. The cooking appliance 100 can be built-in, wall-mounted or freestanding, although other configurations could also be used. The illustrated cooking appliance 100 includes a housing 101, a cooktop surface 106, a cooking cavity 102 with front opening 103 enclosed by the housing 101, a heating element 104, and a door 105 for closing the cavity 102. The embodiment of the cooking appliance 100 in FIG. 1 includes both an oven cooking cavity 102 and a cooktop surface 106 with a plurality of induction heating elements (shown in FIG. 2) operable to elevate the temperature of food items. However, alternate embodiments of the cooking appliance 100 can be a cooktop with induction heating elements, without the oven cavity (such as a drop-in hob), which may be configured to be installed in a kitchen counter or a cabinet, for example.

As further shown in FIG. 2, the cooktop surface 106 can be a substantially-planar ceramic glass pane that conceals a plurality of induction heating elements 14, 16, 18. In alternative embodiments induction heating elements could be replaced with conventional radiant heating elements, where resistively heated coils are concealed beneath the cooktop. However, the remainder of the description will be given with reference to induction heating elements.

In the case of an induction cooktop, the plurality of induction heating elements 14, 16, 18 can be supported below the cooktop surface 106 (often referred to as a “glass top” cooking surface), and cooking vessels can be supported directly upon the cooktop surface 106 vertically above the respective induction heating elements 14, 16, 18. Each heating element 14, 16, 18 can have at least one operational setting, which may relate to a single-segment heating element or a multi-segment heating element. In this regard, the operational setting may relate to the heating element 14, 16, 18 as a whole, or to one or more individual segments of a multi-segment design. Any or all of the induction heating elements 14, 16, 18 can include a single segment or a multi-segment construction that can provide a variable size cooking zone. In the examples shown in FIG. 2, one heating element 14 can include a pair of spaced-apart outer heating segments 14a, 14c with bridge segment 14b located therebetween. In another example, a heating element 18 can include a two or more concentric inner and outer heating segments 18a, 18b, 18c. Thus, for the heating elements 14 or 18, changing the operational settings of the different segments 14a, 14b, 14c or 18a, 18b, 18c with respect to their individual power settings will thereby change the size and/or power output of the cooking zone area provided by each heating element 14, 18. For example, a user could choose to operate element 14a alone for a relatively small cooking pot, or for a low power (e.g., simmer) operation. The user could even choose to operate the outward segments 14a, 14c separately for use with two smaller pots. Alternatively, the user could choose to simultaneously operate two or more adjacent segments (i.e., 14a, 14b or 14b, 14c) or even all three segments (14a, 14b, 14c) if larger cooking vessels are being used (similarly for segments 18a, 18b, 18c).

A user interface 20 (shown in FIG. 2) can control the operations of the induction heating elements 14, 16, 18 according to user inputs or touches on the interface 20. In one example, the user interface 20 can be integrated with the cooktop surface 106 such that the cooktop surface 106 is the external surface of the user interface 20. Alternatively or in addition, the user interface 20 may include conventional knobs, buttons and switches for executing cooking functions as known in the art. The user interface 20 can further include a display 36 for conveying cooking information to the user, such as ON/OFF status or power level/temperature settings of the respective induction heating elements 14, 16, 18, temperature of the cooktop surface 106 or of respective cooking zones embracing the induction heating elements 14, 16, 18, ON/OFF status of a dedicated temperature-sensitive component use mode, alarm conditions, etc.

Temperature sensors 15, 15a, 15b, 15c, 15d are provided within each cooking zone or adjacent to the associated induction heating element of that zone, preferably just beneath (and optionally in contact with) an underside surface of the ceramic/glass pane whose upper surface defines the cooktop surface 106. The temperature sensors 15, 15a, 15b, 15c and 15d transmit temperature signals to the controller 22 providing real-time monitoring of the temperature within each respective cooking zone.

The user interface 20 can include dedicated actuators (e.g. touch buttons, physical switches, etc.) for operating specific features. Example buttons can include an ON-OFF button 50 for activating/deactivating the user interface 20 or even the appliance generally 10, heating element buttons 52 (shown as 52a, 52b, 52c) for selectively operating the particular induction heating elements 14, 16, 18, a heating element size button 54, oven buttons 56 (shown as 56a, 56b, 56c, 56d) for operating the oven cavity 13, and auxiliary control buttons 58 (shown as 58a, 58b, 58c) for operating auxiliary electronic control features, such as the dedicated protection modes described below. Although certain buttons are described, it is understood that any desired buttons can be provided.

A controller 22 (schematically shown in FIG. 2) is operatively connected to the user interface 20, and alters the operational settings of the respective induction heating elements 14, 16, 18 (or individual segments thereof) in response to instructions inputted via the user interface 20, as well as signals from sensors such as the temperature sensor(s) 15, 15a, 15b, 15c, 15d mentioned above.

The controller 22 can be an electronic controller and can include one or more processors for executing a set of programmed instructions that cause the controller 22 to provide the functionality described herein. For example, the controller 22 can include one or more of a microprocessor, a microcontroller, a digital signal processor (DSP), an application specific integrated circuit (ASIC), a system on a chip (SoC), a field-programmable gate array (FPGA), discrete logic circuitry, or the like.

The controller 22 can include memory and may store program instructions that, when executed by the controller 22, cause the controller 22 to provide the functionality ascribed to it herein, and/or to execute other operations with reference to stored configuration files, a plurality of available threshold temperatures that are specific to a particular temperature-sensitive component as indicated via a component-specific user input, lookup tables with temperature values and ranges, a plurality of available predetermined periods of time, predetermined heat warning symbols, etc. The controller 22 can include input/output circuitry for interfacing with the various system components. For example, the controller 22 can receive and interpret signals from the aforementioned temperature sensors or user inputs on the user interface 20, for example. The controller 22 can process these signals to control the operation of cooking appliance, based on these signals. Outputs of the controller 22 can be parameters related to the operation of the induction heating elements 14, 16, 18.

For example, the controller 22 can monitor the temperature sensors 15 and 15a-d for predetermined temperatures and temperature ranges within the respective cooking zones embracing the heating elements. The controller 22 can selectively control a power unit 24 associated with one or more of the induction heating elements 14, 16, 18 to regulate the power thereto in order to control a cooking process in the respective cooking zone. It also can correspondingly activate light-emitting elements of the user interface and/or display devices associated with the respective cooking zones to provide pertinent information or indications related thereto.

The power unit 24 (e.g., conventional induction power boards as known in the art) is operatively connected between the controller 22 and the respective induction heating elements 14, 16, 18, to thereby control electrical power supplied to the induction heating elements 14, 16, 18 (or individual segments thereof). In this manner, the controller 22 (via the respective power unit 24—only one is illustrated, but conventionally there usually is one induction power board associated with—i.e. to supply power to—one or two induction heating elements) can alter respective operational settings of the induction heating elements 14, 16, 18, e.g. by turning them ON or OFF, and by increasing or decreasing a level of power output (e.g., via the supplied voltage) of the induction heating elements 14, 16, 18 (including altering the power output of the heating element as a whole, or to one or more individual segments thereof).

As noted above, each of the temperature sensors 15, 15a, 15b, 15c, 15d can be adjacent one heating element or one cooking zone (which may include a single heating element 14, 16, 18 or multiple heating elements 14a, 14b, and 14c), but remote from the remaining heating elements or cooking zones. Each temperature sensor 15, 15a, 15b, 15c, 15d is typically installed beneath the surface of the cooktop 106 and adjacent the respective heating element 14, 16, 18 for ascertaining and communicating the temperature of each heating element 14, 16, 18 or its associated cooking zone to the controller 22 via communication lines (shown, but not numbered in FIG. 2) that may run beneath the surface of the cooktop 106 from each temperature sensor 15, 15a, 15b, 15c, 15d to the controller 22. Alternatively, the temperature sensors 15, 15a, 15b, 15c, 15d can be disposed beneath the cooktop surface 106 at the center of the respective induction heating elements 14, 16, 18.

In certain embodiments, the cooktop 106 can include one or more additional temperature sensors 26 that may not be adjacent to any particular heating element 14, 16, 18, but that may be remote from all of the induction heating elements 14, 16, 18 and their associated cooking zones. For example, the additional temperature sensor(s) 26 can detect the level of indirect heating of various areas of the cooktop surface 106 from adjacent induction heating elements 14, 16, 18 or cooking zones and communicate information about the temperature of these areas to the controller 22 via communication line(s) (shown, but not numbered in FIG. 2) that may run beneath the cooktop surface 106 from the temperature sensor(s) 26 to the controller 22.

A signal proportionate to or otherwise representative of the measured temperature is generated by each temperature sensor 15, 15a, 15b, 15c, 15d, 26 and sent to the controller 22. The signal(s) generated by each temperature sensor 15, 15a, 15b, 15c, 15d, 26 may be processed by the controller 22 to produce a control signal that is used for temperature-feedback control, as described below. Example temperature sensors 15, 15a, 15b, 15c, 15d, 26 can include thermocouples, thermistors, infrared temperature sensors, etc. In an embodiment in which the temperature sensors 15, 15a, 15b, 15c, 15d, 26 include thermocouples, such a thermocouple for example can output a milli-volt signal that is proportional to a sensed temperature. Thus, by analyzing the signal levels from the various thermocouples, the controller 22 can determine the temperature of the cooktop surface 106 near each of the induction heating elements 14, 16, 18 in the respective cooking zones associated with these heating elements, or it can determine a temperature profile of the cooktop across its surface based on temperature data from discrete points adjacent that surface corresponding to the locations of the thermocouples (or other sensors).

The induction cooking appliance shown in FIGS. 1-3 regulates the temperature in a cooking zone associated with one or more of the respective induction heating elements 14, 16, 18, to ensure that the temperature in that zone does not exceed a predetermined threshold temperature, via an automated algorithm. To facilitate this automated control, each of the induction heating elements 14, 16, 18 is associated, via the controller 22, with a temperature sensor 15, 15a, 15b, 15c, 15d. The temperature sensors 15, 15a, 15b, 15c, 15d can be disposed beneath the cooktop surface 106 at the center of the induction heating elements 14, 16, 18, for example. Preferably, the temperature sensors associated with each cooking zone are disposed beneath the cooktop, at or adjacent to the underside surface of the glass ceramic pane as discussed above. Alternatively, the temperature sensors 15, 15a, 15b, 15c, 15d can be in a different location (perhaps even above the cooktop 106 or in the cooking utensil). The placement of the temperature sensors 15, 15a, 15b, 15c, 15d is not critical, so long as it provides an indication of cooktop surface or cooking-utensil temperature.

In preferred embodiments where the temperature sensors are disposed beneath the cooktop surface 106, they remain in close proximity to the portion of that surface corresponding to the associated heating zone where the cooking utensil rests in-use—i.e. typically just opposite the cooktop surface 106 of the glass ceramic pane, adjacent to its opposing underside surface but in a common geographic location. This way, the temperature for the cooking zone sensed by the temperature sensor is indicative of the temperature of the cooking utensil itself. The noted algorithm monitors cooking-zone (and by extension, cooking-utensil) temperature in real-time, and adjusts (e.g. cuts or reduces) power supplied to the associated induction heating element in case that temperature approaches or meets the predetermined temperature beyond which preservation of a protective mat on the cooktop in the cooking zone, or of a non-stick coating in the cooking utensil thereon, cannot be assured.

The user initiates a temperature-protect mode in order to protect a cooktop-resident protective mat or a non-stick coating in a used cooking utensil by activating a dedicated control input on the control panel. That mode can be associated with a single cooking zone on the cooktop, which may be user-selectable, or it can apply across the entire cooktop in embodiments. When it is user-selectable, the user may activate the temperature-protect mode with respect to a specific cooking zone by actuating a user input specific to that mode in that zone. Alternatively, the user may activate the temperature-protect mode, and then be prompted by the user interface to indicate which cooking zone or zones to which the mode is to be applied. Once active and associated with a cooking zone or zones, the controller 22 executes whatever cooking program is commanded by the user (e.g. as simple as ON 50%, or according to a more intricate cooking program, which can include a user-determined or a pre-programmed temperature profile), all the while monitoring the temperature in the respective zone(s). If that temperature approaches or meets (i.e., is equal to or greater than) the predetermined temperature described above, the controller 22 can cut or reduce power supplied to the affected zone(s) so that the predetermined temperature is not exceeded. Reducing the power supplied to the affected zone(s) also includes removing all power or terminating the supply of power, such that the affected zone is off. Once the measured temperature has receded to a predetermined degree (which can be a specific low-threshold temperature, a specific rate of decline of temperature, or some combination of both), the controller can resume the normally operative program for that cooking zone by increasing or restoring the power supplied to the cooking zone to an operative algorithm for a prevailing cooking operation in that cooking zone. If thereafter the measured temperature approaches the aforementioned predetermined temperature, it will once again intervene to cut or reduce power so that the predetermined temperature (deemed safe for the protective mat and/or nonstick coating in-use on the cooktop) is not exceeded.

In addition to, or in combination with, the aforementioned temperature-protect mode, the user also can be prompted to indicate the type of food to be cooked, for example ‘Steak—medium,’ to call up a predetermined temperature program therefor, which will be executed as noted above while the temperature-protect mode runs in the background to ensure that the threshold temperature is not exceeded. The temperature program can be a constant temperature, or it can be a temperature profile (e.g., a predetermined temp-vs-time function). Thereafter, the temperature sensors 15, 15a, 15b, 15c, 15d measure the temperature in the respective cooking zones, reflective of the temperature at the cooktop surface or of the associated cooking utensil (or their contents), and send temperature signals to the controller 22. The controller 22 in-turn regulates the respective induction coil(s) to maintain the utensil-temperature at the pre-programmed constant value (or on a pre-programmed temperature profile). In this manner, the system maintains a constant temperature (or a predetermined temperature profile) based on feedback control from the temperature sensors. When operating according of such a program, power to the induction heating elements 14, 16, 18 is automatically adjusted by the controller 22 to supply as much or as little power as needed to sustain the preprogrammed constant (or profiled) temperature, irrespective of how much or how little food is placed in (or even removed from) the utensil while cooking.

However, in most conventional applications currently, induction heating coils are set instead simply to a preselected power level (e.g. a level between 1 and 10), and not to maintain a particular temperature or temperature program. Either way, the disclosed algorithm can run in the background to ensure that actual temperature does not approach or exceed a preselected threshold temperature, e.g. beyond a predetermined degree and/or for more than a predetermined period of time. The predetermined degree of the preselected threshold temperature can be, e.g., 0, 1, 2, 3, 4 or 5 degrees, 10 degrees, 15 degrees or 20 degrees. A plurality of available threshold temperatures that are specific to a particular temperature-sensitive component, as indicated via a component-specific user input, can be stored in the memory of the controller 22. The predetermined period of time can be, e.g. 0, 1, 2, 3, 4 or 5 seconds, 10 seconds, 15 seconds, 30 seconds, or 60 seconds. A plurality of available predetermined period of time can be stored in the memory of the controller 22. This will be most useful in cases where the controller 22 merely sets a power level for the induction coil and is not operating according to a temperature-feedback program, because theoretically the latter already should avoid undesirably high temperatures. But in case a particular program would call for a temperature or temperature segment that exceeds the preselected threshold based on the protection algorithm, or some other circumstance might result in unintended higher temperatures (e.g. a boil-dry condition), the algorithm will prevent the cooktop/utensil temperature from exceeding the threshold that may otherwise damage a mat or coated cookware on the cooktop surface.

As shown in FIG. 2, a removable protective mat 19 can be placed above each heating element 14, 16, 18 or above a cooking zone embracing several of the induction heating elements 14, 16, 18 (only the protective mat 19 of heating element 14a is shown in FIG. 2). The protective mat 19 can be made of a magnetically transmissive material that permits the magnetic field from the induction heating elements 14, 16, 18 to pass through the mat 19 to a cooking utensil placed on the mat 19. For example, the protective mat 19 can include a silicone pad or a layer. The protective mat 19 may be shaped as a circular disk dimensioned to cover each of the induction heating elements 14, 16, 18. Alternatively, the protective mat 19 may be dimensioned to cover one larger cooking zone embracing several of the induction heating element 14, 16, 18. In certain embodiments, the protective mat 19 may be shaped as a rectangular, square or other-shaped sheet dimensioned to cover one of the induction heating elements 14, 16, 18, two of the induction heating elements 14, 16, 18, all heating elements 14, 16, 18, or the entire cooktop surface 106. The protective mat 19 can be substantially planar. The protective mat 19 may be temperature resistant only up to a certain predetermined temperature, such as at least 500° F., for example.

The protective mat 19 can be transparent or translucent, or it can have any other desired finish, which can be realized via suitable dopants or additives to a pre-cured silicone composition used to produce a silicone rubber mat once cured. Alternatively, the protective mat 19 may not be made of silicone rubber, but rather could be made of other synthetic or plastic materials. Silicones may be desirable because their compressibility and elasticity can produce a pad having self-healing properties that is unlikely to be marred by scratches or gouges, because it will self-heal following scratch- or gouge-producing insults.

The protective mat 19 may be secured to the top panel of the cooktop 106 at a location or locations above one or more of the induction heating elements 14, 16, 18 where the cooktop panel may be susceptible to scratches and dings from contact with other implements, such as metal cookware, for example. The location(s) where the protective mat 19 is placed may be indicated by graphical symbols that reflect the locations of heating zones (corresponding to the geographic locations of the induction heating elements 14, 16, 18) on the cooktop surface 106. The protective mat 19 may be placed above one or more of the induction heating elements 14, 16, 18, and be secured on the cooktop surface 106 by force of gravity and/or by a cooking utensil placed on the protective mat 19. The protective mat 19 can be configured to be easily removable by simply lifting the mat 19 off the cooktop surface 106.

In addition (or alternatively) to using such a protective mat 19, non-stick-coated cookware also can be used on the cooktop. That is, the use of non-stick cookware is not necessarily tied to or related to the use of a protective mat 19, as the two perform different functions. A protective mat 19 is used to protect the cooktop (usually glass) from scratches or other damage as may be occasioned by placing or sliding heavy metal cooking utensils (commonly used for induction) on the cooktop. Whereas non-stick coatings reduce the incidence of cooked food sticking to the cooking utensils, making them easier to use and easier to clean. However, these two features (i.e. protective mats and non-stick utensil coatings) do share in common that both typically can be damaged beyond certain threshold temperatures (which are not necessarily the same) that could otherwise be generated in a respective heating zone of the cooktop. The disclosed temperature-protection mode can ensure that the heating zone does not exceed a threshold temperature known to be safe for either (or both) the protective mat 19 or (and) a non-stick coating of the cooking utensil, thus making either (or both) of them safe and appropriate to use in a cooking process.

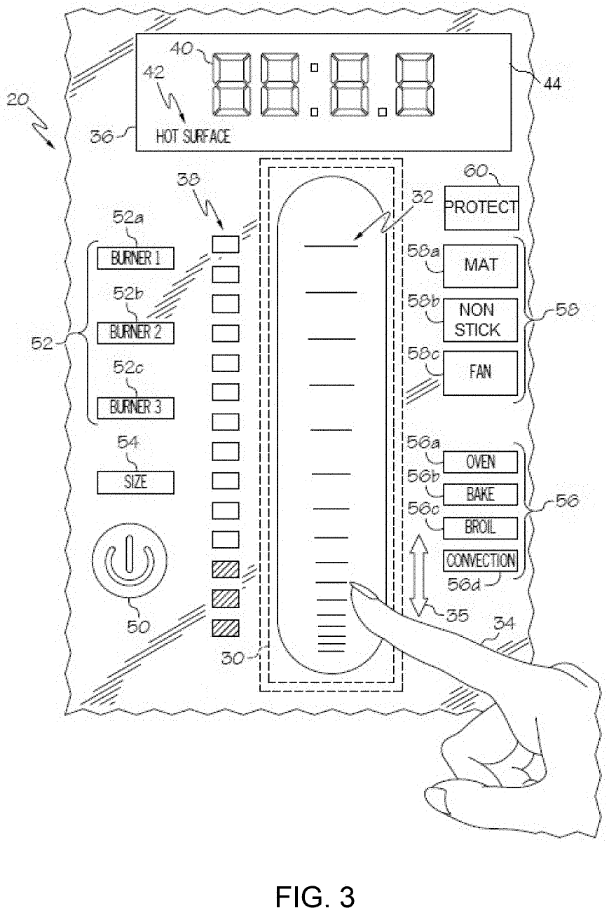

The presence of the protective mat 19 or the presence of a non-stick coated cooking utensil on the surface of the cooktop 106 may be detected in response to a manual user input on the user interface 20. For example, as illustrated in FIG. 3, the manual user input on the user interface 20 may be performed through a button 60 (“PROTECT”) dedicated to activation of a temperature-protect mode as herein described. Separate buttons 58a (“MAT”) and 58b (“NON-STICK”), also may be present for a user to indicate what particular feature (i.e. a non-stick coated utensil or a protective mat) will be present and is to be protected via the temperature-protect mode. This can be useful, e.g., if the different features to be protected might benefit from different protective-threshold temperatures. For example, if a non-stick coating would require a lower threshold than a protective mat and an uncoated cooking utensil is used, then selecting the MAT function could be programmed to permit a higher threshold temperature prior to intervention, thus resulting in faster cooking/boiling times.

When appropriate inputs are made by the user via one or more of the buttons 60, 58a, and 58b, the controller 22 receives a signal that it is to operate in a temperature-protect mode as described. If only PROTECT is selected, for example, then that mode may operate according to a particular temperature threshold that is fairly conservative, i.e. it is selected to ensure that no protective mat or non-stick coating is likely to be damaged, regardless which (or the particular composition of which) may be used. Further, if separate MAT and/or NON-STICK buttons are present and actuated, each can be programmed to effect its own respective temperature threshold that the associated cooking zone(s) will not be permitted to exceed. These respective thresholds can be made specific to the particular feature that is to be protected; i.e. non-stick coatings generally or protective mats generally. Further still, it is recognized that different protective mats 19 and/or non-stick coatings may have their own ‘safe’ temperatures. If desired, the user interface can include further inputs that will allow the user to select a particular mat or category of mat, which inputs will be preprogrammed with corresponding threshold temperatures. Ideally, the threshold should be as high as possible to balance the competing interests of permitting fast cook/boil times and ensuring that a mat/coating is not heated to a temperature that may damage it. Providing tailored inputs that are specific to such different features and their materials, if applicable, could serve this purpose by ensuring the highest reasonable threshold is available and will be used for the particular mat and/or coating that needs protected.

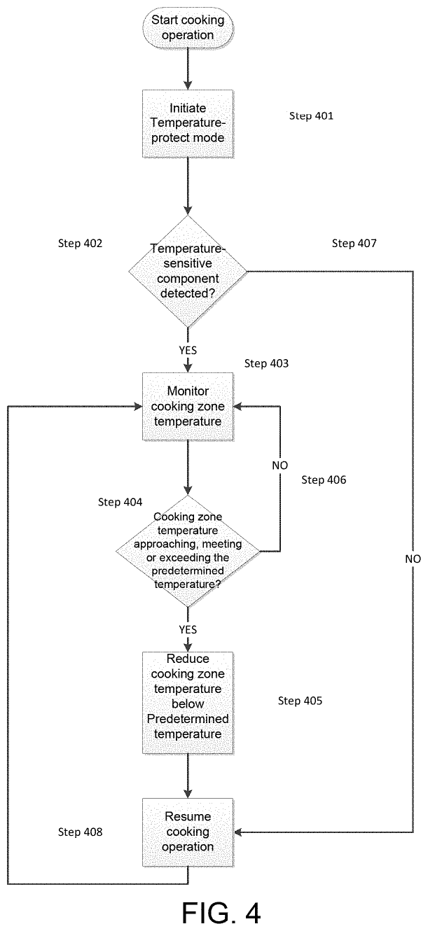

As further shown in FIG. 4, in Step 401, the user initiates temperature-protect mode. When a temperature-sensitive component, such as the protective mat 19 and/or the non-stick coated cooking utensil is detected on the cooktop surface 106 (e.g., through manual user input)—Step 402 in FIG. 4, a protect mode is activated and the controller 22 monitors the temperature of the affected cooking zone(s) (Step 403 in FIG. 4) based on signal(s) generated by the associated temperature sensor(s) 15, 15a, 15b, 15c, 15d, and 26. If the temperature of the affected cooking zone(s) reaches or exceeds a predetermined threshold temperature, such as 500 degrees Fahrenheit, for example (Step 404 in FIG. 4), the controller 22 outputs a control signal to the associated power unit 24 to reduce power supplied to the related heating element(s) to ensure that the predetermined threshold temperature is not exceeded (Step 405 in FIG. 4); or is not exceeded by more than a particular amount and/or for more than a particular length of time. Reducing the power supplied to the related heating element(s) also includes removing all power or terminating the supply of power, such that the respective heating element is off. Once the measured temperature has receded to a predetermined degree (which can be a specific low-threshold temperature, a specific rate of decline of temperature, or some combination of both), the controller 22 resumes the normally operative program for that cooking zone (Step 408 in FIG. 4). Specifically, upon the detected temperature falling to a predetermined low temperature that is lower than the threshold temperature, the controller 22 increases or restores the power supplied to the affected cooking zone(s) to an operative algorithm for a prevailing cooking operation in that cooking zone. After that, the controller 22 continues to monitor the temperature of the affected cooking zone(s) (Step 403 in FIG. 4). If thereafter the measured temperature approaches or exceeds the aforementioned predetermined temperature, e.g. beyond a predetermined degree and/or period of time, the controller 22 will once again intervene (repeating Steps 404-408 in FIG. 4) to cut or reduce power so that the predetermined temperature (deemed safe for the protective mat and/or nonstick coating in-use on the cooktop) is not exceeded. The controller continuously monitors the temperature in the affected cooking zone(s), and will adjust power to the associated heating element(s) to ensure that threshold is not reached throughout the cooking operation.

Preferably the aforementioned temperature-protect mode is persistent, i.e., once activated it remains in force even through on-and-off cycles of the cooking appliance until the user manually deactivates the temperature-protect mode via one or more of the buttons 60, 58a, and 58b, for example. That is, if the temperature-protect mode is operative at the time the appliance is turned off, it will remain active the next time the appliance is turned on, until the temperature-protect mode is manually deactivated.

When a temperature-sensitive component, such as the protective mat 19 and/or the non-stick coated cooking utensil is not detected (e.g., via manual user input) (Step 407 in FIG. 4), the controller 22 will not execute a temperature-protect mode, and the cooking zone(s) will not be constrained to stay below a threshold temperature associated with that mode. In this situation, the controller 22 will resume the normally operative program for that cooking zone (Step 408 in FIG. 4) by increasing or restoring the power supplied to the affected cooking zone to an operative algorithm for a prevailing cooking operation in that cooking zone. That is not to say temperature will be totally unconstrained. For example, the appliance may be programmed to ensure that cooktop temperature never exceeds a maximum threshold temperature (e.g. one that might damage the cooktop itself) in any event. But in the absence of a temperature-protect mode, no associated thresholds will be applicable and cooking processes may be executed by the controller 22 according to a fixed power setting (e.g., 5 out of 10) or a preprogrammed temperature profile if applicable for the induction heating elements 14, 16, 18.

Illustrative embodiments have been described, hereinabove. It will be apparent to those skilled in the art that the above apparatuses and methods may incorporate changes and modifications without departing from the general scope of this disclosure. The disclosure is intended to include all such modifications and alterations disclosed herein or ascertainable herefrom by persons of ordinary skill in the art without undue experimentation.

1. A cooking appliance comprising:
a cooktop having a cooking zone;
at least one heating element disposed beneath the cooktop in the cooking zone;
a temperature sensor configured to detect a temperature of the cooking zone; and
a controller configured to execute a temperature-protect mode upon receiving an indication of a presence of a temperature-sensitive component on a surface of the cooktop, said controller in said temperature-protect mode being configured to:
receive from said temperature sensor a temperature signal corresponding to the detected temperature of the cooking zone; and
adjust power supplied to said heating element in response to said detected temperature approaching, meeting or exceeding a threshold temperature in order to ensure that the detected temperature does not exceed the threshold temperature beyond a predetermined degree and/or for a predetermined period of time, said threshold temperature having been predetermined to be one that will not damage said temperature-sensitive component.

2. The cooking appliance of claim 1, wherein said controller is adapted to receive said indication based on a first manual user input to activate said temperature-protect mode.

3. The cooking appliance of claim 2, wherein the temperature-protect mode is persistent, even following an off-on cycle for the cooking appliance, until the controller receives a second manual user input to deactivate the temperature-protect mode.

4. The cooking appliance of claim 1, wherein said temperature-sensitive component comprises a removable protective mat configured to protect against abrasion of the surface of the cooktop.

5. The cooking appliance of claim 4, wherein the removable protective mat is a silicone mat.

6. The cooking appliance of claim 1, wherein the threshold temperature is 500 degrees Fahrenheit.

7. The cooking appliance of claim 1, wherein the temperature-sensitive component comprises a cooking utensil having a non-stick coating applied at an inner surface of the cooking utensil.

8. The cooking appliance of claim 1, said controller being configured to reduce the power supplied to said heating element in said temperature-protect mode in response to said detected temperature reaching said threshold temperature, said predetermined degree being 0°.

9. A method for operating a temperature-protect mode on a cooking appliance, the method comprising:
receiving an indication of a presence of a temperature-sensitive component on a cooktop surface in a cooking zone thereof;
receiving from a temperature sensor a temperature signal corresponding to a detected temperature of the cooking zone; and
adjusting power supplied to a heating element that supplies cooking energy to said cooking zone in response to said detected temperature approaching, reaching or exceeding a threshold temperature in order to ensure that the detected temperature does not exceed the threshold temperature beyond a predetermined degree and/or a predetermined period of time period of time, said threshold temperature having been predetermined to be one that will not damage said temperature-sensitive component.

10. The method of claim 9, wherein said indication is received in response to a first manual user input.

11. The method of claim 10, wherein the temperature-protect mode persists, even following an off-on cycle for the cooking appliance, until receiving a second manual user to deactivate the temperature-protect mode.

12. The method of claim 9, wherein said temperature-sensitive component comprises at least one of a removable protective mat configured to protect against abrasion of the cooktop surface or a non-stick coated cooking utensil.

13. The method of claim 9, wherein the threshold temperature is 500 degrees Fahrenheit.

14. The method of claim 9, said threshold temperature being selected from a plurality of available threshold temperatures stored in a memory of the cooking appliance and being specific to a particular temperature-sensitive component as indicated via a component-specific user input.

15. The method of claim 9, wherein power to the heating element is reduced in response to said detected temperature reaching said threshold temperature, said predetermined degree being 0°.

16. The method of claim 15, wherein the power to the heating element is increased or restored to an operative algorithm for a prevailing cooking operation in the cooking zone upon the detected temperature falling to a predetermined low temperature lower than the threshold temperature.
